(19) United States
(12) Patent Application Publication
(10) Pub. No.: US 2009/0188767 A1
(43) Pub. Date: Jul. 30, 2009

(54) HYDRAULIC SYSTEM OF A CLUTCH OF A MOTOR VEHICLE TRANSMISSION

(75) Inventors: Michael Niko, Schwieberdingen (DE); Joachim Esser, Rutesheim (DE); Peter Baur, Moensheim (DE); Arne Kruger, Karlsruhe (DE)

Correspondence Address: LERNER GREENBERG STEMER LLP, P O BOX 2480, HOLLYWOOD, FL, 33022-2480, US

(73) Assignee: DR. ING. H.C. F. PORSCHE AKTIENGESELLSCHAFT, Weissach (DE)

(21) Appl. No.: 12/359,355

(22) Filed: Jan. 26, 2009

(30) Foreign Application Priority Data
Jan. 26, 2008 (DE) 10 2008 006 165.4

(51) Int. Cl. F16H 61/00

(52) U.S. Cl. 192/70.12

(57) ABSTRACT

A hydraulic system for a clutch has a pump conveying a hydraulic fluid stream via a heat exchanger to a controllable hydraulic valve which divides the hydraulic fluid stream into a first part stream and a second part stream. The first part stream flows to a reservoir via friction linings of the clutch and the second part stream flows to the reservoir via a hydraulic path bypassing the friction linings. The hydraulic system is set up for upgrading a cooling of the clutch by increasing the first part stream at the expense of the second part stream and for reducing the cooling of the clutch by increasing the second part stream. The system is set up for temporarily upgrading the cooling of the clutch in the event of a changeover of torque transfer from transfer via a first part transmission to transfer via a second part transmission of the transmission.

### CROSS-REFERENCE TO RELATED APPLICATION

This application claims the priority, under 35 U.S.C. § 119, of German application DE 10 2008 006 165.4, filed Jan. 26, 2008; the prior application is herewith incorporated by reference in its entirety.

### BACKGROUND OF THE INVENTION

### Field of the Invention

The invention relates to a hydraulic system of a clutch of a motor vehicle transmission.

Such a hydraulic system is known from published, non-prosecuted German patent application DE 10 2005 013 137 A1. It has a pump which conveys a hydraulic fluid stream to a controllable hydraulic valve via a heat exchanger. The hydraulic valve divides the hydraulic fluid stream into a first part stream and a second part stream. The first part stream flows to a reservoir via friction linings of the clutch, and the second part stream flows to the reservoir via a hydraulic path bypassing the friction linings. The known hydraulic system is set up for upgrading a cooling of the clutch by increasing the first part stream at the expense of the second part stream and for reducing the cooling of the clutch by increasing the second part stream at the expense of the first part stream.

The hydraulic valve, designated in published, non-prosecuted German patent application DE 10 2005 013 137 A1 as a changeover valve, is in this case arranged in a low-pressure branch between an oil cooler on one side and, on the other side, the clutch, serving as a starting element, and elements of a transmission lubrication system. The hydraulic valve controls the distribution of a cooling oil stream emerging from the cooler to an oil line leading to the elements of the transmission lubrication system and an oil line going to elements of the starting element cooling.

As regards the activation of the changeover valve, the known hydraulic system distinguishes between three types of operation. In a first type of operation, with the vehicle engine switched off, an electric oil pump is driven and the changeover valve is actuated in such a way that the supply of lubricating oil to the transmission and the supply of cooling oil to the starting element are at least for the most part prevented. In a second type of operation, in which the vehicle starts up, a mechanical and an electric oil pump are driven in parallel and the changeover valve is essentially opened in order to supply cooling oil to the starting element. In a third type of operation, there is provision for the mechanical oil pump to be driven and for the electric oil pump to be at a standstill, the changeover valve being opened in order to supply lubricating oil to the transmission and being essentially closed with regard to the supply of cooling oil to the starting element. Furthermore, the third type of operation is characterized in that, for a lengthy time after a starting operation, the vehicle is traveling quickly at a medium or high engine rotational speed, so that the mechanically drivable pump can supply all the consumers in the oil supply system sufficiently, and an aftercooling of the starting element takes place to only a slight extent.

It is stated elsewhere in published, non-prosecuted German patent application DE 10 2005 013 137 A1 that the demand for cooling fluid for the drive clutch is particularly high precisely during starting operations when, in shift operations of the transmission during travel, mostly only relatively low loads on the drive clutch will occur. Overall, therefore, DE 10 2005 013 137 A1 teaches providing a cooling oil stream only during starting, but not during shifting.

Furthermore, hydraulic systems for automatic transmissions with a torque converter as the starting element are known, in which the entire oil stream of the transmission is routed through an oil cooler and is consequently cooled.

Moreover, double clutch transmissions for motor vehicles are known. Such double clutch transmissions consist, as a rule, of two part transmissions which on the output side act on the same shaft and on the drive side can be connected in each case to an engine via a clutch individual to each part transmission. These double clutch transmissions are distinguished, inter alia, in that they are shiftable without any interruption in traction, the torque being transferred before the shift operation via one of the clutches and the assigned part transmission and, after the shift operation, being transferred via the other clutch and the other assigned part transmission. These double clutch transmissions are used preferably in high-performance vehicles. It has been shown that the assumption, presupposed in DE 10 2005 013 137 A1, that, in shift operations of the transmission during travel, mostly only relatively low loads on the drive clutch occur, is not always applicable to double clutch transmissions in high-performance vehicles.

### SUMMARY OF THE INVENTION

It is accordingly an object of the invention to provide a hydraulic system of a clutch of a motor vehicle transmission that overcomes the above-mentioned disadvantages of the prior art devices of this general type, which is set up for high-performance vehicles equipped with a double clutch transmission.

With the foregoing and other objects in view there is provided, in accordance with the invention, a hydraulic system for a clutch of a motor vehicle transmission. The hydraulic system contains a heat exchanger, a controllable hydraulic valve, a reservoir, a hydraulic path, and a pump for conveying a hydraulic fluid stream via the heat exchanger to the controllable hydraulic valve which divides the hydraulic fluid stream into a first part stream and a second part stream, of which the first part stream flows to the reservoir via friction linings of the clutch and the second part stream flows to the reservoir via the hydraulic path bypassing the friction linings. The hydraulic system is set up for upgrading a cooling of the clutch by increasing the first part stream at an expense of the second part stream and for reducing the cooling of the clutch by increasing the second part stream at an expense of the first part stream. The hydraulic system is set up for temporarily upgrading the cooling of the clutch in an event of a changeover of torque transfer from transfer via a first part transmission to transfer via a second part transmission of the motor vehicle transmission.

The hydraulic system according to the invention differs from the prior art according to published, non-prosecuted German patent application DE 10 2005 013 137 A1 in that it is set up for temporarily upgrading the cooling of the clutch in the event of a changeover of torque transfer from transfer via a first part transmission to transfer via a second part transmission of the motor vehicle transmission. As a result, the introduction of heat into the hydraulic fluid, which occurs during the changeover of torque transfer as a result of slip on the two clutches involved, can be discharged on demand.

At the same time, due to the on-demand opening of the hydraulic valve, undesirable secondary effects, which may occur in the event of a permanent flow through the double clutch, are restricted to an extent which has to be taken into account for cooling purposes. These undesirable secondary effects include a foaming of the hydraulic fluid and an occurrence of drag moments (torques).

When it flows through the double clutch, the hydraulic fluid is thrown off from the rotating clutch components, for example the lamellae, particularly at high rotational speeds. In this case, the undesirable formation of oil foam may occur.

Moreover, a permanent throughflow would increase drag moments. This applies particularly to double clutch transmissions, since these even make it possible to engage a gear in a second part transmission while torque transfer between the engine and transmission output is still taking place via the first part transmission. The gear preselected and engaged in this situation in the second part transmission is also designated as a shadow gear. The clutch of the second part transmission is in this case driven by the common transmission output and, due to the throughflow, experiences a drag moment which reduces the power effective on the wheels of the vehicle (a power loss of 0.3 to 0.5 kW was observed at 1500 rev/min in a specific engine) and increases the consumption.

Furthermore, these drag moments would make it difficult to engage the shadow gear, since the drag moment generated by the throughflow and effective on the associated clutch impedes synchronization. This would lead, furthermore, in the long term, to a more rapid wear of the synchronizing device.

A particularly preferred refinement therefore provides for the hydraulic system to be set up for cutting off or not upgrading a cooling of the clutch during the preselection of a specific step-up in the part transmission currently transferring no torque, that is to say during the engagement of the shadow gear.

It will be appreciated that the features mentioned above and those yet to be explained below can be used not only in the combination specified in each case, but also in other combinations or alone, without departing from the scope of the present invention.

Other features which are considered as characteristic for the invention are set forth in the appended claims.

Although the invention is illustrated and described herein as embodied in a hydraulic system of a clutch of a motor vehicle transmission, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a block diagram of an exemplary embodiment of a hydraulic system of a clutch of a motor vehicle transmission according to the invention; and

FIG. 2 is a block diagram of a more concrete implementation of a hydraulic circuit having features of the invention.

### DETAILED DESCRIPTION OF THE INVENTION

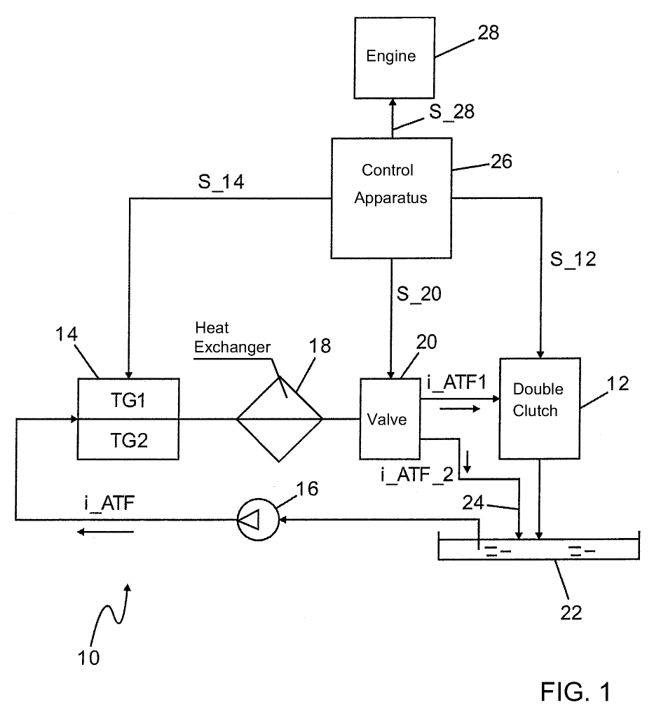

Referring now to the figures of the drawing in detail and first, particularly, to FIG. 1 thereof, there is shown a hydraulic system 10 of a double clutch 12 of a double clutch transmission as a motor vehicle transmission 14. The hydraulic system 10 has a pump 16 which conveys a hydraulic fluid stream i_ATF to a controllable hydraulic valve 20 via a heat exchanger 18. The pump 16 sucks the hydraulic fluid ATF out of a reservoir 22, puts it under a specific pressure and feeds the hydraulic fluid stream i_ATF into the double clutch transmission 14 which has two part transmissions TG1, TG2. In the double clutch transmission 14, the hydraulic fluid ATF serves for lubrication, cooling and control. Control takes place in that the pressure of the hydraulic fluid is utilized for the actuation of gear actuators, by which step-up ratios within the part transmissions are changed.

After emerging from the double clutch transmission 14, the hydraulic fluid stream i_ATF is routed through the heat exchanger 18. The heat exchanger 18 is implemented in an embodiment as an oil/water heat exchanger, through which the cooling fluid of the engine of the motor vehicle flows. The temperature of the hydraulic fluid is thus adapted to the temperature of the cooling fluid. The hydraulic fluid stream emerging from the heat exchanger 18 is subsequently divided by the hydraulic valve 20 into a first part stream i_ATF_1 and a second part stream i_ATF_2.

The order of the double clutch transmission 14 and the heat exchanger 18 may also be reversed with respect to the through flow of hydraulic fluid. By contrast, it is essential that the division of the hydraulic fluid stream i_ATF by the hydraulic valve 20 into a first part stream i_ATF_1 and a second part stream i_ATF_2 takes place only after the throughflow of the double clutch transmission 14.

The first part stream i_ATF_1 flows to the reservoir 22 via friction linings of the double clutch 12 which are configured, as a rule, as lamellae. The second part stream i_ATF_2 flows to the reservoir 22 via a hydraulic path 24 bypassing the friction linings.

The division of the hydraulic fluid stream i_ATF into the first part stream i_ATF_1 and the second part stream i_ATF_2 in this case takes place such that the ratio of the two part streams i_ATF_1, i_ATF_2 is not constant, but is varied, on demand, by the hydraulic valve 20. For this purpose, the hydraulic system 10 is set up, in particular, for carrying out the division such that a cooling of the clutch 12 is upgraded by increasing the first part stream i_ATF_1 at the expense of the second part stream i_ATF_2 and is cut off by increasing the second part stream i_ATF_2 at the expense of the first part stream i_ATF_1.

For this purpose, the hydraulic valve 20 is activated from a control apparatus 26 by actuating signals S_20, in particular, such that the cooling of the clutch 12 is temporarily upgraded in the event of a changeover of torque transfer from transfer via a first part transmission TG1 to transfer via a second part transmission TG2 of the motor vehicle transmission 14.

Depending on the particular embodiment, the control apparatus 26 is a control apparatus which also controls the internal combustion engine 28 by actuating signals S_28, the double clutch transmission 14 by actuating signals S_14 and the clutch 12 by actuating signals S_12 or is a control apparatus which controls only a part quantity of these components, in extreme case only the hydraulic valve 20. If a plurality of control apparatuses are used for controlling the components mentioned, they are, as a rule, connected to one another via a bus system which makes available all the information required for controlling the hydraulic valve 20 and present in one of the control apparatuses.

A particularly preferred embodiment of the hydraulic system 10 is distinguished in that it is set up for cutting off or not upgrading a cooling of the clutch 12 during the preselection of a specific step-up in the part transmission currently transferring no torque. As a result, the synchronizing operation, which is necessary during the engagement of the new gear in the part transmission affected and by which, inter alia, the rotational speed of the transmission-side part of the clutch of the part transmission affected is adapted to the driving speed, is not disturbed. As already mentioned, a hydraulic fluid stream via the clutch affected would generate disturbing drag moments which would impede synchronization.

The invention makes it possible, in particular, always to flow with the largest possible hydraulic fluid volume stream i_ATF through the heat exchanger 18 for the optimal cooling of the double clutch transmission 14, without this volume stream i_ATF constantly having to be discharged via the clutch 12. Arranging the hydraulic valve 20 between the heat exchanger 18, on one side, and the clutch 12 and the reservoir 22, on the other side, affords the possibility of causing the potentially cooling hydraulic fluid stream i_ATF to flow, on demand, completely into the clutch 12 (i_ATF=i_ATF_1). Alternatively, when there is no demand for cooling the clutch 12 or when drag moments are to be reduced or avoided, the hydraulic fluid stream i_ATF can be conducted completely past the clutch 12 into the reservoir 22 (i_ATF=i_ATF_2). Depending on the configuration of the hydraulic valve 20, divisions lying between these extreme cases, with i_ATF=i_ATF_1+i_ATF_2 and i_ATF_1 unequal to 0 and equal to or unequal to i_ATF_2, are also possible.

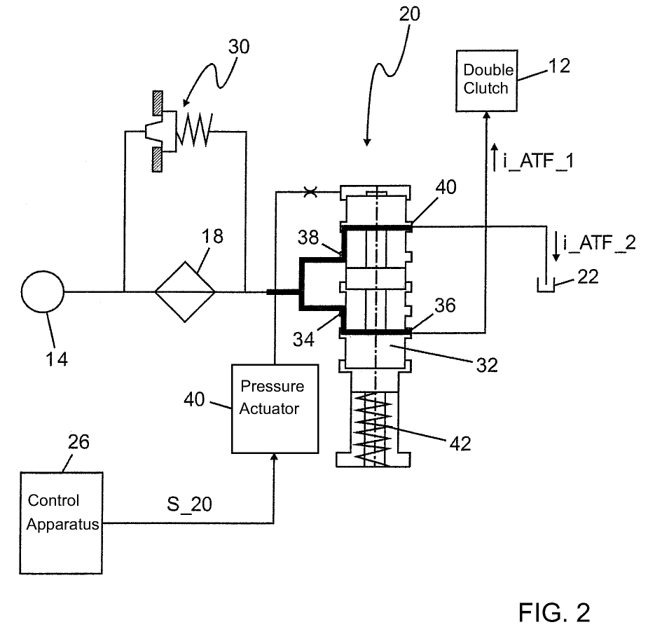

FIG. 2 shows a more concrete implementation of the hydraulic circuit having features of the invention. In this case, the same reference symbols designate identical elements in each case in FIGS. 1 and 2. In the embodiment of FIG. 2, a bypass valve 30 lies parallel to the heat exchanger 18 in order to limit a pressure drop across the heat exchanger 18. The hydraulic valve 20 has a spring-loaded control piston 32 which, depending on the deflection from its position of rest, opens or shuts off a first flow path between a first inlet 34 and a first outlet 36 and/or a second flow path between a second inlet 38 and a second outlet 40. The control piston 32 is actuated by a pressure actuator 40 which is itself controlled electrically by the control apparatus 26 by actuating signals S_20.

Without activation, spring 42 presses the control piston 32 upward. In this position, the first flow path is opened and the second flow path is closed. The entire hydraulic fluid stream i_ATF flows via the first flow path and thereafter past the clutch 12 into the reservoir 22. In the event of full activation, the control piston is pressed downward counter to the spring force. The first flow path is in this case closed, while the second flow path is fully upgraded. The entire hydraulic fluid stream i_ATF is thereafter conducted via the clutch 12. By the appropriate activation of the pressure actuator 40, for example by a pulse width-modulated signal, any desired divisions of the hydraulic fluid stream into the two part streams i_ATF_1 and i_ATF_2 can be set, at least on average in any period of time.

1. A hydraulic system for a clutch of a motor vehicle transmission, the hydraulic system comprising:
a heat exchanger;
a controllable hydraulic valve;
a reservoir;
a hydraulic path; and
a pump for conveying a hydraulic fluid stream via said heat exchanger to said controllable hydraulic valve which divides the hydraulic fluid stream into a first part stream and a second part stream, of which the first part stream flows to said reservoir via friction linings of the clutch and the second part stream flows to said reservoir via said hydraulic path bypassing the friction linings, the hydraulic system being set up for upgrading a cooling of the clutch by increasing the first part stream at an expense of the second part stream and for reducing the cooling of the clutch by increasing the second part stream at an expense of the first part stream, the hydraulic system being set up for temporarily upgrading the cooling of the clutch in an event of a changeover of torque transfer from transfer via a first part transmission to transfer via a second part transmission of the motor vehicle transmission.

2. The hydraulic system according to claim 1, wherein the hydraulic system is set up for one of cutting off and not upgrading the cooling of the clutch during a preselection of a specific step-up in the first and second part transmission currently transferring no torque.
